(19) United States
(12) Patent Application Publication
(10) Pub. No.: US 2010/0025609 A1
(43) Pub. Date: Feb. 4, 2010

(54) DEVICE MOUNT FOR SINK OR BASIN

(75) Inventors: Peter A. Pubben, Calgary (CA); Gregory Vincent Browne, Victoria (CA); Scott Phillips, Victoria (CA); Chris Denny, Victoria (CA)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: Tapmaster Incorporated, Calgary, AB (CA)

(21) Appl. No.: 12/445,726

(22) PCT Filed: Oct. 16, 2007
(86) PCT No.: PCT/CA07/01832

§ 371 Date: Apr. 15, 2009

Related U.S. Application Data
(60) Provisional application No. 60/829,657, filed on Oct. 16, 2006.
(60) Provisional application No. 60/890,782, filed on Feb. 20, 2007.

(51) Int. Cl. F16K 31/46; E03C 1/05; E03B 1/00

(52) U.S. Cl. 251/213; 4/619; 137/607; 29/428

(57) ABSTRACT

A mount for a device, such as a faucet controller or valve actuator assembly for mounting the device to a sink or basin having carrier arm mounting holes. A valve actuator assembly for operating a valve for a sink or basin and operable with a push pad, the valve actuator assembly having a housing mountable to the sink or basin, the housing supporting a shaft and a valve, the shaft rotatable between a normal at rest position and a valve operating position, a rocker operably connected with a shaft, for rotation with the shaft, the rocker having an extent for operably urging a member supporting the valve when the shaft in is the valve operating position, and a push pad mechanism operably connected with the shaft and the push pad to selectively activate the valve.

### CROSS REFERENCE TO RELATED APPLICATION

This application claims the benefit of priority of U.S. Provisional Patent Application No. U.S. 60/829,657 filed Oct. 16, 2006 and the benefit of priority of U.S. Provisional Patent Application No. U.S. 60/890,782 filed Feb. 20, 2007, which are incorporated herein by reference in their entirety.

### FIELD OF THE INVENTION

The present invention relates generally to a mount for mounting a device, such as a faucet controller to a sink or basin and a valve actuator operable with a body part or limb.

### BACKGROUND OF THE INVENTION

It has been amply demonstrated by a variety of studies and research that conventional hand operated faucets are a source of wasted water and energy and a cross contamination point for the spread of infectious diseases. Several devices have been developed and marketed to overcome these problems but all have some disadvantages. Mechanical foot pedal or knee operated faucets are expensive and often require extensive and costly modifications to plumbing and cabinetry. Infra-red sensor electrically operated faucets are costly to install, require an electrical outlet, may be erratic in operation and may permit cold and hot water cross flow. Foot pedal valves controlling the application of air pressure to water controlling valves are expensive and often difficult to install and require a compressed air source. Of these, ultrasound sensor electrically operated valves require batteries and are too bulky to comfortably adapt to many faucets. Other types operate by a foot control supplying fluid pressure through flexible tubing connected to a spout mounted valve. These tend to be untidy and cumbersome to operate. Examples of such devices are described and illustrated in U.S. Pat. No. 5,029,806, dated Jul. 9, 1991 granted to Chaung for a “Foot-Controlled Valve” and in U.S. Pat. No. 3,536,294, dated Oct. 27, 1970, granted to Rodrigues for a “Foot-Operated Control Valve Attachment Device for Water Faucets.”

Faucet controllers may include a metering feature, which typically includes an orifice which is subject to plugging and mineralization or a reservoir which is bulky and subject to plugging, mineralization, and leakage.

U.S. Pat. No. 5,505,227 granted to Pubben, discloses a “hands free” system for controlling the flow of water to a faucet. The system includes a pilot valve which provides pilot water of controlled pressure to operate diaphragm valves in a control block. The valves in the control block may be respectively connected between hot and cold water supply lines and a faucet. The pilot valve may be located in a position where it can be operated by a user's knee or elbow, or in another location where foot operation is possible.

There are a wide variety of configurations for the design and installation of sinks or basins, known to one who is ordinarily skilled in the art. Three common configurations include “wall-mount”, “counter-mount”, and “carrier arm mount”.

In a wall-mount or wall-hung configuration, the sink or basin is mounted to the wall and extends outward from the wall in a cantilever fashion. Optionally, legs or other supports may provide additional support to the free end. This configuration is very common for public spaces such as restrooms, industrial buildings, and for health related facilities such as hospitals and other medical facilities.

In a counter-mount configuration, a counter support is provided with a cut-out to suit the sink and basin, and the sink or basin is dropped in (drop-in counter-mount) or supported beneath the counter (under counter-mount). This configuration is very common for public spaces such as restrooms in commercial buildings and shopping malls.

In a carrier arm mount, a fixture carrier is utilized to support the sink or basin. The fixture carrier is mounted to the floor and/or wall behind the sink or basin and carrier arms extend in a cantilever fashion from the fixture carrier to support the sink or basin, generally with as little of the carrier arms visible as possible. The sink or basin is attached to the carrier arms by openings in the underside of the sink or basin, commonly referred to as carrier arm mounting holes, or hidden carrier arm holes.

It is, therefore, desirable to provide a mount for a device, for example an actuator that is adaptable to a number of different configurations. It is, therefore, desirable to have a simple valve actuator operable by either hip, arm, elbow, foot or knee etc. and easily installed in association with a sink or basin having carrier arm mounting holes.

### SUMMARY OF THE INVENTION

It is an object of the present invention to obviate or mitigate at least one disadvantage of previous knee/thigh actuator mounts and valve actuator assemblies. It is an object of the present invention to obviate or mitigate at least one disadvantage of previous faucet controller assemblies.

In a first aspect, the invention provides a mount for mounting a device to a sink or basin having carrier arm mounting holes, the mount having a universal arm adapted to fixedly connect with the device, and a fastener adapted to fixedly mount the universal arm to at least one of the carrier arm mounting holes. Preferably, the device is a faucet controller or a pilot valve.

In a further aspect, the invention provides a valve actuator assembly for operating a valve for a sink or basin and operable with a push pad, the valve actuator assembly having a housing mountable to the sink or basin, the housing supporting a shaft and a valve, the shaft rotatable between a normal at rest position and a valve operating position, a a rocker operably connected with a shaft, for rotation with the shaft, the rocker having an extent for operably urging a member supporting the valve when the shaft in is the valve operating position, and a push pad mechanism operably connected with the shaft and the push pad, wherein the push pad is adapted to move the shaft between the normal at rest position and the valve operating position to selectively activate the valve.

In a further aspect, the invention provides a method of mounting a device to a sink or basin by locating at least one hole in the underside of the sink or basin, inserting a fastener into the hole, activating the fastener to lock the fastener in the hole, and mounting a device to the sink or basin by attachment to the fastener. Preferably the device is a faucet controller or a pilot valve. Preferably, the hole is a carrier arm mounting hole.

In a further aspect, the present invention provides a faucet controller for operating a valve mounted in association with a sink or basin, having a carrier arm mounting hole having a mounting means for mounting the valve to carrier arm mounting hole, a joystick actuator mountable on the valve for movement between a normal at rest position and a valve operating position, and a member connected with the joystick for forcing the joystick actuator into the valve operating position.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a knee/thigh actuator mount and valve actuator assembly of the present invention, with dual universal arms;

FIG. 2 is a universal arm and fastener of the present invention;

FIGS. 3a-g are exemplary fasteners of the present invention;

FIG. 4 is a perspective view of a valve actuator of the present invention;

FIG. 5 is a side view of the valve actuator of FIG. 4;

FIGS. 6a-b are perspective views of a valve activator and a universal arm in accordance with the present invention;

FIG. 7 is a perspective view of a valve activator and a universal arm in accordance with the present inventions;

FIG. 8 is a knee/thigh actuator mount and valve actuator of the present invention with a push pad;

FIG. 9 is a valve actuator assembly of the present invention (with the housing and the push pad removed);

FIG. 10 is a sub-assembly of a valve actuator of the present invention;

FIG. 11 is a sub-assembly of a valve actuator of the present invention; and

FIG. 12 is a representation of a plurality of configurations of a universal arm mount in accordance with the present invention.

### DETAILED DESCRIPTION

Generally, the present invention provides a mount for mounting a device valve actuator or activator such as a sink or basin or counter and a valve actuator.

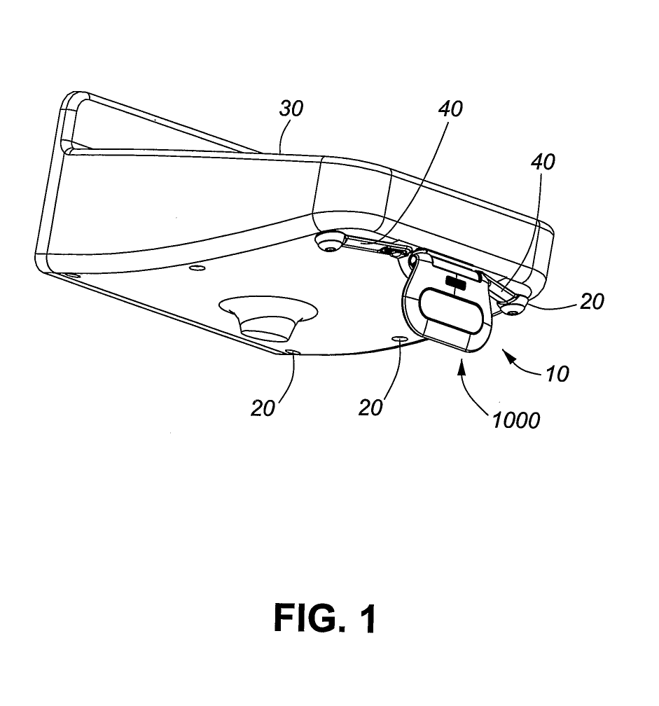

Referring to FIG. 1, a mount 10 for a valve actuator assembly 1000 is shown affixed to universal arms 40 to fixedly mount the valve actuator assembly 1000 to the front carrier arm mounting holes 20 of a sink or basin 30.

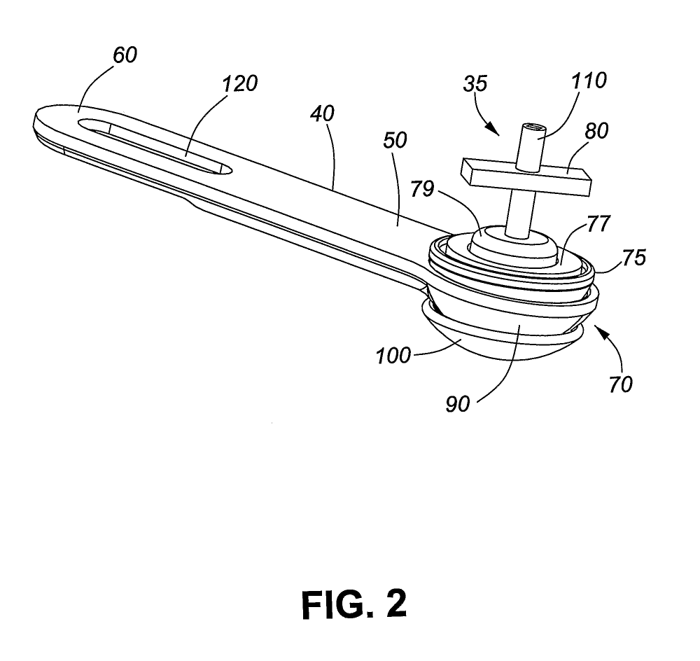

Referring to FIG. 2, a typical universal arm 40 extends between a sink or basin end 50 and a valve actuator assembly end 60. The sink or basin end 50 is attachable to the sink or basin 30 by fastener 35 and the valve actuator assembly end 60 is attachable to a valve actuator assembly 1000.

The sink or basin end 50 includes a flexible, swivel, or gimbaled connection in the form of a ball joint 70. The ball joint 70 includes a half sphere plinth 75 fixedly attachable to the carrier arm mounting hole 20 by fastener 35 in the form of a bar 80. A centralizer 79 may be matched to the size of the carrier arm mounting holes 20. A cup 90 is formed into the universal arm 40. The ball joint 70 is completed by a cover cap 100 and is fixed in place by a fastener in the form of a screw 110.

Fastener 35 in the form of bar 80 in conjunction with the screw 110 is used to fasten the universal arm 40 to the carrier arm mounting holes 20 of the sink or basin 30 (FIG. 1). It is recognized by one ordinarily skilled in the art that different types and configurations of fastener 35 may be used, and that the screw and bar configuration is but one example. Further examples include clips, wing nut, spring loaded wing nut, expansion anchors, adhesives, and winged anchors.

As shown, the fastener 35 in the form of a bar 80 is more suitable to the ceramic (porcelain) type sink or basin having an outer wall, an inner wall, and void between the outer and inner wall, the carrier arm mounting holes 20 providing the ability to place the bar 80 in the void and then be tightened against the outer wall by the screw 110 to fasten the universal arm 40 to the sink or basin 30. Other sink or basin 30 designs or constructions may provide cylindrical carrier arm mounting holes 20, for which other fasteners, known to one skilled in the art may be more suitable, for example expansion anchors.

A compressible washer 77, for example a rubber or acetyl washer, fits between the half sphere plinth 75 and the sink or basin 30 (FIG. 1). The bar 80 may be coated, for example with a rubber to provide a compressible connection with the sink or basin 30.

The centralizer 79 may be of such a height (relative to the half sphere plinth 75 and in relation to the outer wall thickness of the sink or basin 30) that when the bar 80 is tightened by screw 110, the bar 80 rests upon the centralizer 79 to limit the amount of force the bar 80 imparts upon the sink or basin 30.

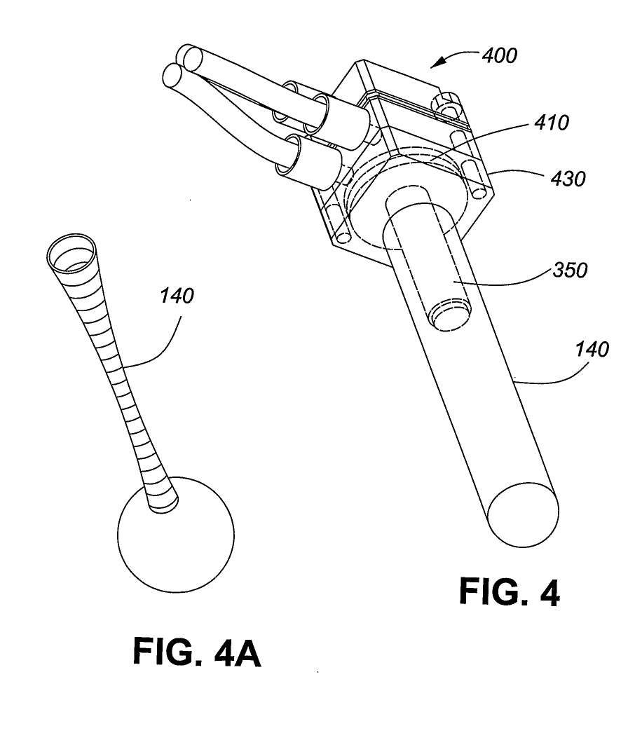

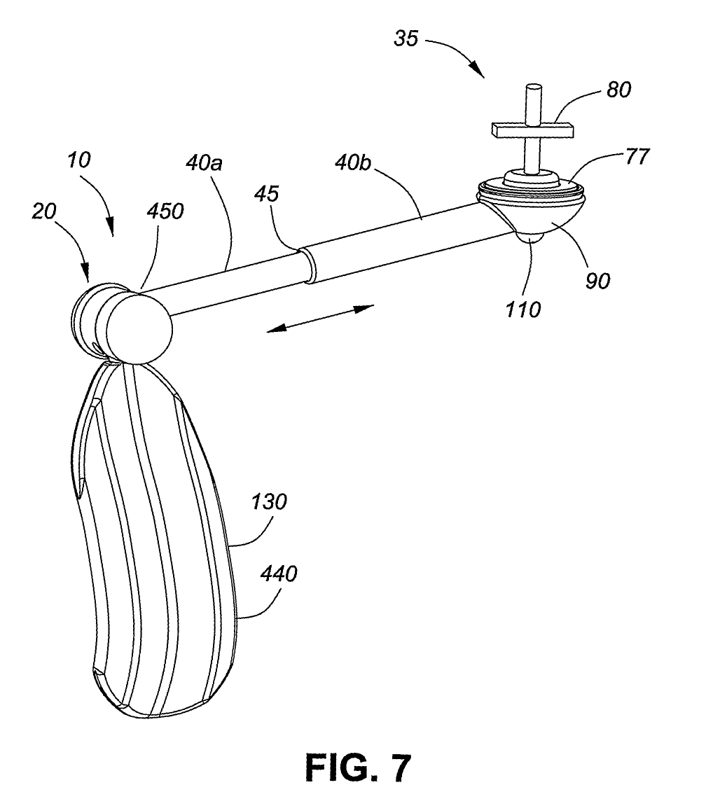

The valve actuator assembly end 60 of the universal arm 40 includes connection means for connecting the valve actuator assembly 1000 (FIG. 7) or the faucet controller 5 (FIG. 4) and the universal arm 40. As shown, connection means in the form of a elongate slot 120 mating with a fastener 127 (FIG. 7) provides longitudinal adjustment.

It is recognized by one ordinarily skilled in the art that, while the ball joint 70 and the universal arm 40 provide a degree of adjustability or universality, the present invention may be embodied in configurations lacking these features. For example, a variant of the valve actuator assembly 1000 could connect directly to the sink or basin 30 provided the valve actuator assembly 1000 included extended arms which correspond to the sink or basin 30 to position the fastener 35 in a position to mate with at least one carrier arm mounting hole 20.

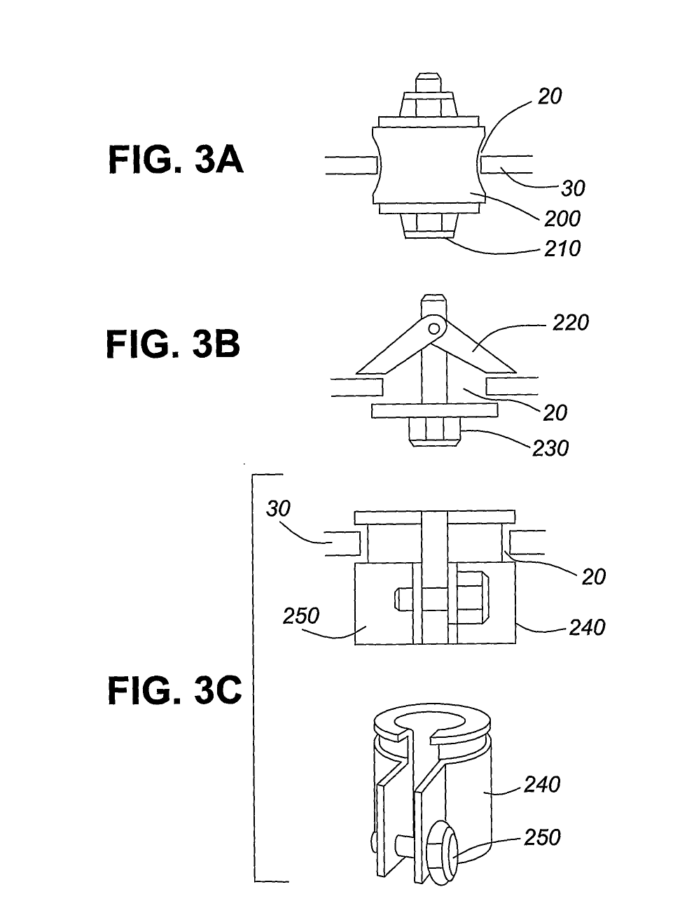

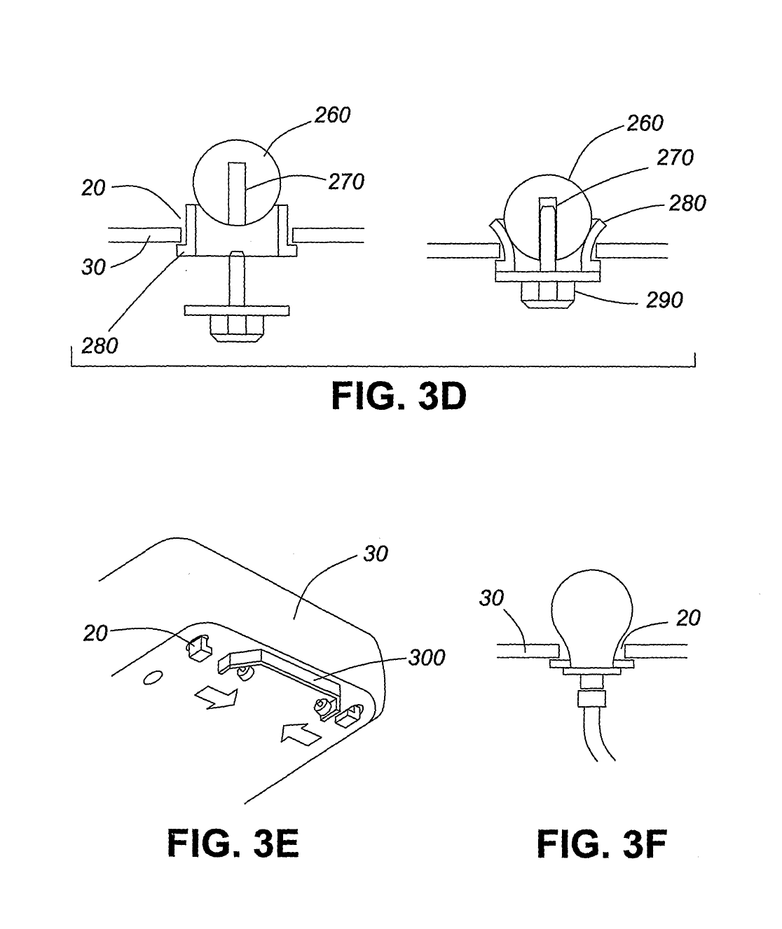

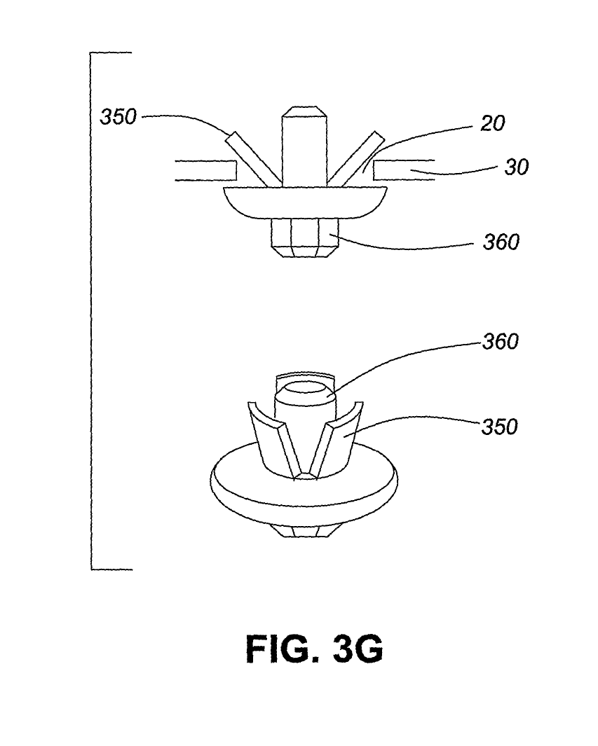

Referring to FIG. 3 a variety of exemplary fasteners 35 of the present invention are depicted. Each or a combination may be used with a universal arm 40 or a device (for example a valve activator) of the present invention. In FIG. 3a, a rubber body 200 is adapted to fit within carrier arm mounting hole 20. The rubber body 200 is adapted to expand radially upon the tightening of a screw bolt 210. In FIG. 3b, a biased pivoting retainer (e.g. spring loaded retainer 220) is adapted to be collapsably inserted within a carrier arm mounting hole 20. The spring loaded retainer 220 is adapted to engage the sink or basin 20 upon the tightening of a screw bolt 230. In FIG. 3c, a biased collar 240 is adapted to be collapsably inserted within a carrier arm mounting hole 20. The biased collar 240 is adapted collapse sufficiently upon the tightening of a screw bolt 250, such that the biased collar 240 may be received in the carrier arm mounting hole 20, and upon loosening of the screw bolt 250, the biased collar 240 engages the carrier arm mounting hole 20. In FIG. 3d, a ball 260 having a channel 270 is adapted to fit within a carrier arm mounting hole 20 upon a sleeve 280. The sleeve 280 is adapted to engage the carrier arm mounting hole 20 upon the tightening of a screw bolt 290, the screw bolt 290 received in the ball 260. In FIG. 3e, a mounting plate 300 engages two carrier arm mounting hole 20, a first hook 310 in one carrier arm mounting hole 20 and a second hook 320 in another carrier arm mounting hole 20, with a turnbuckle 330 adapted to secure the mounting plate 300 to the sink or basin 30. While shown across a front or leading edge of the sink or basin 30, the mounting plate 300 may be used along either side of the sink, or the rear or trailing edge of the sink or basin 30. In FIG. 3f, an inflatable balloon 340 is adapted to fit within a carrier arm mounting hole 20 when the inflatable balloon 340 is in a deflated state. However, upon inflation, the inflatable balloon 340 fixedly retains a mount relative to the sink or basin 30. In FIG. 3g, push rivet having a plurality of sleeves or prongs 350 is adapted to engage a carrier arm mounting hole 20. Upon tightening of a screw bolt 360, the sleeves or prongs 350 are adapted to flare out or spread out to secure fastener to the sink or basin 30.

Referring to FIG. 4, a faucet controller 5 in accordance with the present invention is intended for operation of a valve 400 mounted in association with a sink or basin 30 (for example directly or indirectly mounted to at least one carrier arm mounting hole 20). The valve 400 is operable by moving a whisker 140 between a normal, at rest, position and a valve actuating position. A member 130 in the form of a whisker 140 is fixedly attached to the joystick 350, whereby movement of the whisker 140 translates into movement of the joystick 100. Preferably, the whisker 140 is constructed of an elastic material, such as a plastic or rubber or spring material such as steel (e.g. straight or coiled or curved etc.). Alternatively, the whisker 140 may be constructed of a relatively rigid material, such as a plastic or stainless steel, or a combination of elastic and relatively rigid materials. Regardless of the materials chosen, preferably, the whisker 140 is provided in at least a partially elastic configuration to provide operational comfort and feedback to a user of the faucet controller 5 as well as facilitate easier cleaning around the whisker 140.

While shown as a relatively straight, elastic member, the whisker 140 may function in a wide variety of configurations, shapes and sizes. For example, but not limited to, a beaver tail, paddle, arm, cylinder, cone, curved, spiral, sinusoidal, zigzag etc. and may be long, short, slender, narrow, wide etc.

Depending on the material or combination of materials chosen, the whisker 140 may end up being very slender, for example if constructed out of straight spring steel. In such cases, and optional guard (not shown) in the form of an enlarged sphere or disk may be added to the end of the whisker 140 to improve visibility and improve ergonomics.

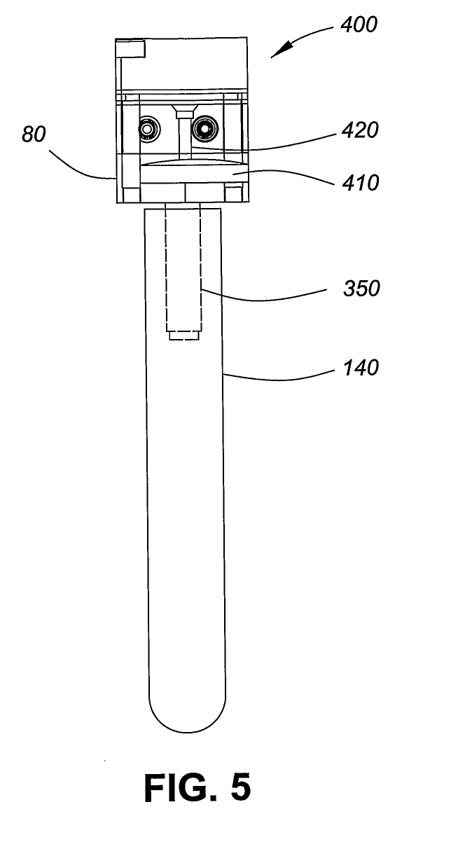

The whisker 140 may be identified by color to designate the fluid delivered by the faucet (not shown) being controlled by the faucet controller 10, for example red for hot, blue for cold, red and blue for mix, or otherwise marked. The whisker 140 may be made in a variety of configurations. Preferably, as shown in FIG. 4, the whisker 140 is an elongate, relatively slender member. However, one skilled in the art would recognize that the specific configuration of the whisker 140 may be adapted to the particular environment and style or decor of the installation. The whisker 140 may extend substantially to the floor (not shown) or may provide a gap (not shown) between the floor (not shown) and the whisker 140. Referring to FIG. 5, the valve 400 is operable by a disc 410 mountable on the valve 400 for pivotal reciprocation between a normal at rest position and a valve operating position. The valve 400 is preferably biased into the normal at rest position. The valve 400 preferably is operated by a valve piston 420 reciprocal in a disk housing 80. The disc 70 is housed within the disk housing 430 and operatively associated with the valve piston 420 to activate the valve 400 such that pressure on the disc 410 by way of movement of a joystick 350 axially displaces the valve piston 420 to activate the valve 400.

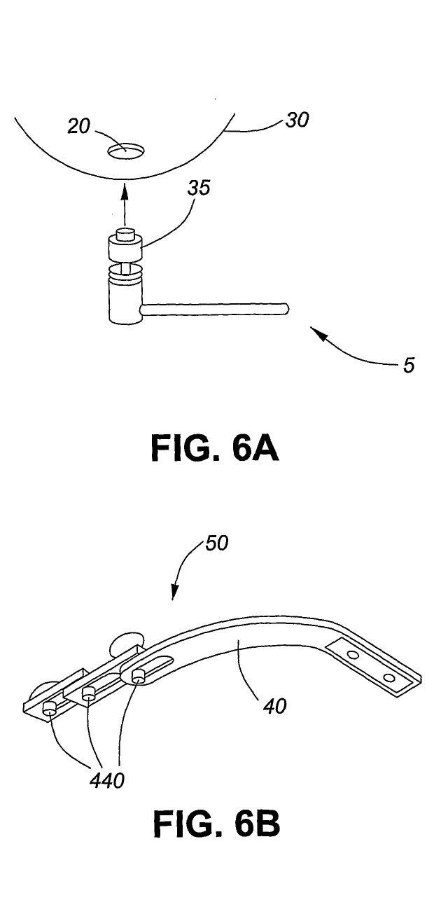

Referring to 6a a faucet controller is mounted directly to at least one carrier arm mounting hole 20. Referring to FIG. 6b, a universal arm 40 may engage at least one carrier arm mounting hole 20 (but preferably at least two carrier arm mounting hole 20, for example along the front, rear, or a side or sides of a sink or basin 30). The universal arm 40 may support a device (not shown) mounted using at least one carrier arm mounting hole 20. By way of example only, the device may be equipment (such as lighting), an accessory holder (such as a cup holder or a towel holder), a faucet controller 5 (using a paddle, whisker, knee action stirrup, handle or foot pedal), a working surface (such as a table or a workbench), a product dispenser (such as paper towel), or hygienic materials (such as a towel, soap, wash clothes, or a mirror). These are only example, and one ordinarily skilled in the art recognizes that there are a variety of devices which may be mounted to a sink or basin 30 utilizing the carrier arm mounting hole 20.

Referring to FIG. 6a, faucet controller 5, for example of the type shown in FIGS. 4-5 is mountable directly to a sink or basin 30 via a fastener 35 which engages one or more carrier arm mounting hole 20.

Referring to FIG. 6b, a universal arm 40 is connected to a sink or basin 30 (not shown) a plurality of adjustment points 440 provide improved fit for a variety of locations.

Referring to FIG. 7, a mount 10 includes a fastener 35 like that of FIG. 2. The universal arm 40 includes a joint 45 (shown as telescoping) such that a first portion 40a and a second portion 40b are relatively movable, but may be fixed in place. Joint 45 may include, for example, telescoping, swivel or a pivot, or may be fixed. Releasable or non-releasable locking means (for example welding or adhesive) may be used to fix the joint in place. A faucet controller 5, having a beaver tail 440 actuator/activator, is connected with the universal arm 40 by joint 450. Joint 450 may include, for example, telescoping, swivel or a pivot, or may be fixed. Releasable or non-releasable locking means (for example welding or adhesive) may be used to fix the joint in place.

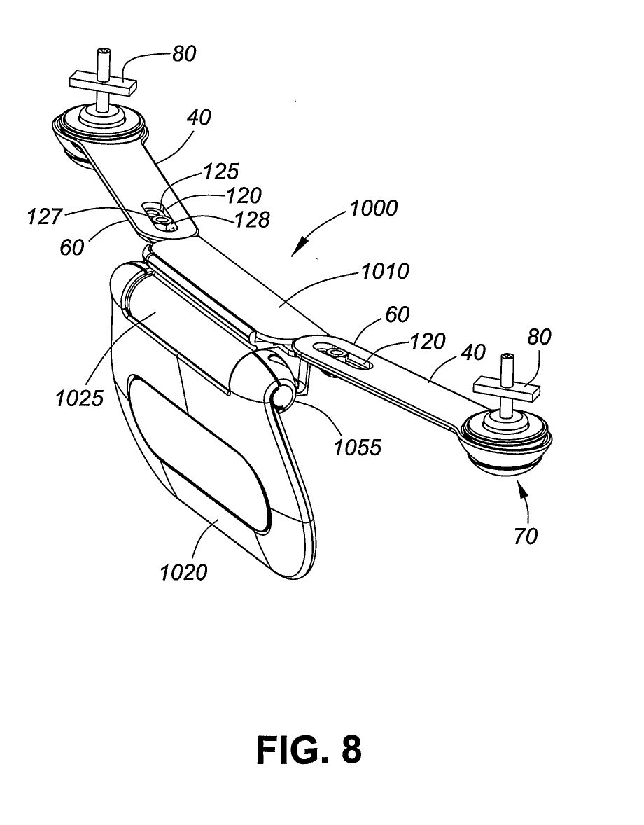

Referring to FIG. 8, a typical valve actuator assembly 1000 may attach to the universal arms 40 by a mounting brace 1010 extending between the valve actuator assembly end 60 of two universal arms 40. The elongate slot 120 provides a channel 125 which may be adapted to rotationally constrain a portion of the fastener 127, such as a nut 128, to facilitate easier installation, as the nut 128 may not be easily accessible in certain configurations.

This configuration provides a very adjustable, yet very solid mounting of the valve actuator assembly 1000 to the sink or basin 30. The valve actuator assembly 1000 is operable by a push pad 1020, movable between a normal at rest position and a valve operating position, and movable between the valve operating position and an overtravel position. A housing 1025 contains and generally conceals the inner workings.

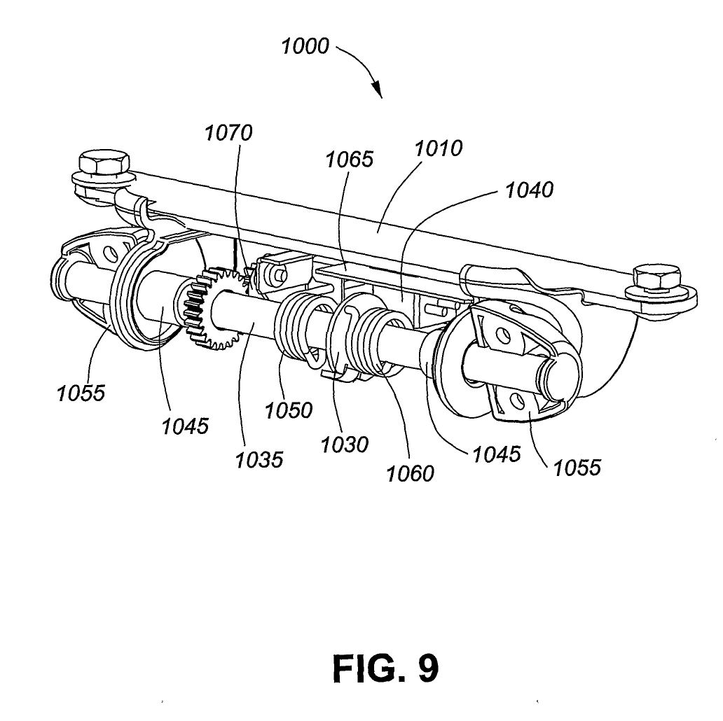

Referring to FIG. 9 (with the housing 1025 removed), a shaft 1035 is fixedly connected with the push pad 1020 (FIG. 8) by clamping the shaft 1035 between the push pad 1020 and a universal end piece 1055 such that movement of the push pad 1020 between it's normal at rest position, valve operating position, and overtravel position produces corresponding movement of the shaft 1035. In the preferred embodiment, the valve actuator assembly 1000 includes bias means in the form of a torsion spring 1050 to return the shaft 1035 (and the corresponding push pad 1020) to the normal at rest position. A rocker 1030 is configured to activate a valve 1040, held in place by a bracket 1065, when the shaft 1035 is rotated into the valve operating position. The valve 1040 is operably connected to control the flow of water (or other fluid). The valve actuator 1000 is particularly suitable for valves of the type disclosed in U.S. Pat. No. 5,505,227 to Pubben, but is also applicable to other types of valves, particularly 3-way pilot valves that can be actuated by the depression of a piston or a buton or any valve that can be operated by relative movement of its parts.

In the preferred embodiment, the rocker 1030 is rotatably movable relative to the shaft 1035 and held in place by bias means in the form of a torsion spring 1060 and a snap in bushing (not shown). The torsion spring 1060 allows the push pad 1020 (and the corresponding shaft 1035) to move between the valve operating position and the overtravel position while allowing the rocker 1030 to remain in the valve actuation position, reducing the forces applied to the valve 1040 when the push pad 1020 is pushed into the overtravel position and provides additional bias to return the shaft 1035 (and the corresponding push pad 1020) to the valve operating position. A hard stop (not) shown may be incorporated into the valve actuator mechanism 1000 or the push pad 1020 may be come into contact the underside of the sink or basin 30 at an extreme overtravel position.

In the preferred embodiment, damping means in the form of damper 1070, for example a rotary dashpot or viscous fluid damper may be operably connected with the shaft 1035, thereby damping the movement of the shaft 1035 (and the associated push pad 1020).

The valve actuator assembly 1000 may include a metering feature by selecting the spring rates of the torsion spring 1050 and/or torsion spring 1060 and the damping rate of the damper 1070 to produce a desired time meter. When a user pushes the push pad 1020 it is biased to return to the normal at rest position, but that return motion may be damped, thus providing a metering effect. The metering feature may be user controllable or selectable, such that a greater push of the push pad 1020 produces a greater metered time than that of a lesser push, providing the user a simple but effective means of handsfree metering faucet.

A metering feature is particularly advantageous to knee/thigh type actuators, in that it allows the user to activate (and then release) the push pad 1020 and then perform a task while the water continues to flow, for example leaning over the sink or basin to wash their face or obtaining some equipment or material from a laboratory bench for rinsing, without having to maintain pressure on the push pad 1020 with their knee or thigh.

The metering feature of the present invention is free from the mineralization, plugging, and bulkiness of orifice and reservoir type metering systems.

The torsion springs may be linear or non-linear. The damper 1070 may be linear or non-linear.

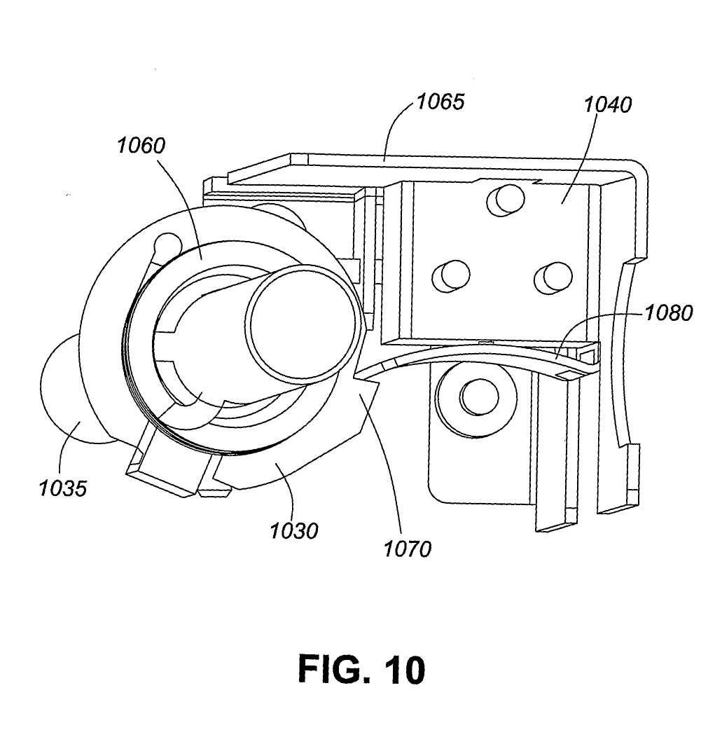

Referring to FIG. 10 the rocker 1030 is configured to activate the valve 1040 when the shaft 1035 is rotated into the valve operating position. The rocker 1030 has an extent in the form of a lip 1070 which catches a member 1080 and the member 1080 is urged upwards to active the valve 1040. The member 1080 may be curved and/or operate as a lever to reduce the degree of rotation of the shaft 1035 necessary to activate the valve. The member 1080 may be weakened by removal of a portion of the member 1080 to reduce the amount of force necessary to urge the member 1080 (and thus activate the valve).

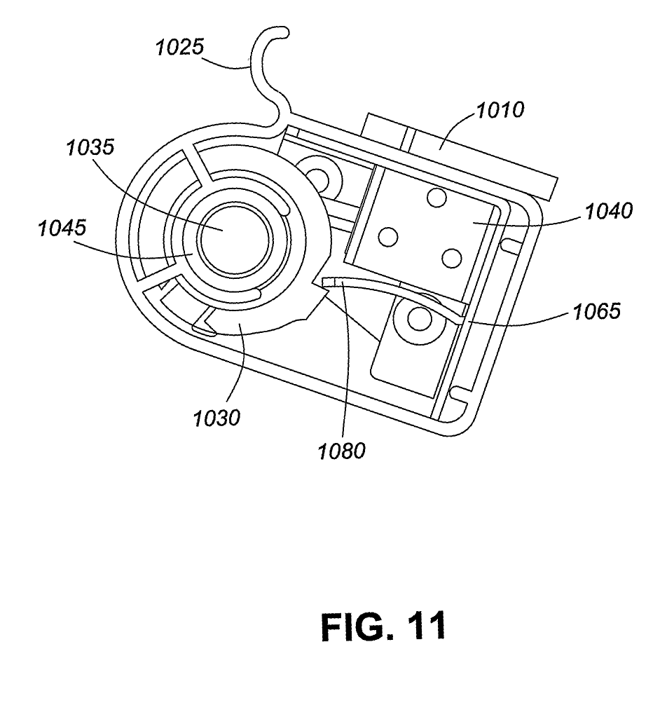

Referring to FIG. 11, the shaft 1035 is supported by bushings 1045 which are supported by the housing 1025. The housing 1025 also supports the bracket 1065 for mounting the valve 1040.

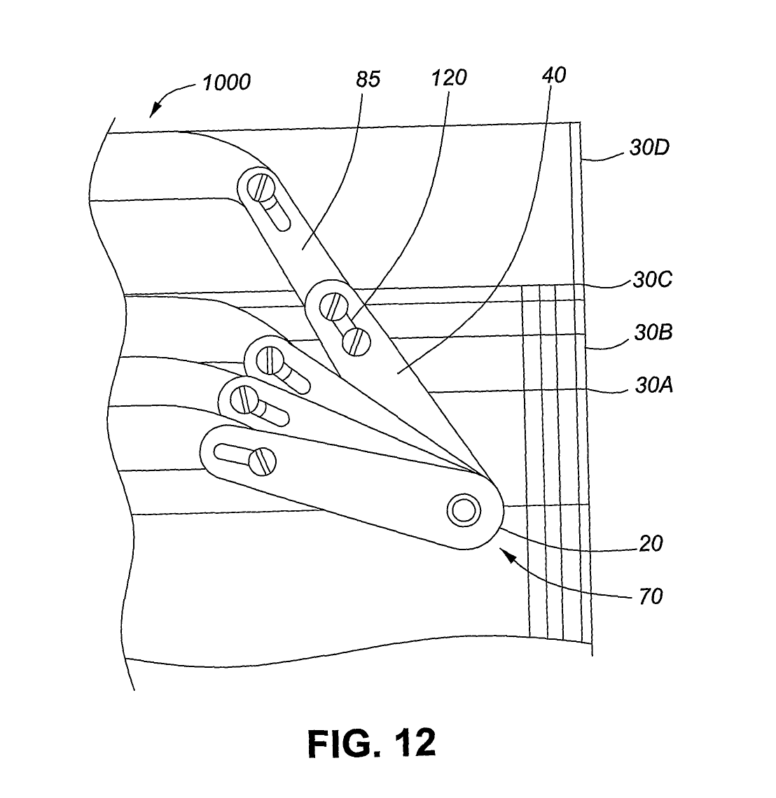

Referring to FIG. 12, the universal arm 40 is rotatable within the carrier arm mounting hole 20 (when the ball joint 70 is not tightened), and the elongate slot 120 provides longitudinal adjustment, which allows a device such as a faucet controller 5 or the valve actuator assembly 1000 to be selectively positioned relative to the sink or basin 30. It is commonly desired to position the valve actuator 1000 at or near the front surface of the sink or basin 30. Together, these features allow a particular geometry of universal arm 40 to fit a large number of different sizes, different carrier arm mounting hole setbacks, and configurations of sink or basins 30A, 30B, 30C, 30D. An optional arm extender 85 provides further universality for mounting a device such as a faucet controller 5.

In a variant of the present invention, the universal mounting arms 40 (and the associated fastener 35) may be used to mount other types, configurations and designs of valve actuator assemblies, for example knee action stirrup handles or foot pedals to fixtures, such as the sink or basin 30, and may be used to mount other devices, equipment, controls, or accessories to fixtures, such as the sink or basin 30.

Referring to FIG. 5, although a single installation of the faucet controller 5 is shown, it is obvious to one skilled in the art that a plurality of installations of the faucet controller 5 are included in the present invention, for example, two in a hot/cold configuration, three in a hot/mix/cold configuration, two in a soap/water configuration, two in a solvent/air configuration, four in a fluid A/fluid B/fluid C/fluid D configuration etc.

The faucet controller 5 (or a plurality of the faucet controllers 5) may be installed in a variety of configurations, elevations, orientations, etc. For example, but not limited to, installations suitable for operation of the faucet controller 5 by activation by a user's finger, hand, arm, elbow, shoulder, hip, leg, knee, calf, foot, toe etc.

In operation, a device such as a faucet controller 5 is selectively mounted directly or indirectly to a carrier arm mounting hole 20 by fastener 35.

In operation, application of pressure to the whisker 140 via a user's finger, hand, arm, elbow, shoulder, hip, leg, knee, calf, foot, toe etc. or other means causes movement of the joystick 350, thus causing pivotal movement of the disc 410 within the disk housing 430 to depress the valve piston 420, causing the valve 400 to move between a normal at rest position and a valve operating position. Release of the pressure on the whisker 140 allows the joystick 350 of the valve 400 to return to the normal at rest position.

The whisker 140 may be removable from the joystick 350 (and/or may be user replaceable).

In the preceding description, for purposes of explanation, numerous details are set forth in order to provide a thorough understanding of the embodiments of the invention. However, it will be apparent to one skilled in the art that these specific details are not required in order to practice the invention.

The above-described embodiments of the invention are intended to be examples only. Alterations, modifications and variations can be effected to the particular embodiments by those of skill in the art without departing from the scope of the invention, which is defined solely by the claims appended hereto.

What is claimed is:

1. A mount for mounting a device to a sink or basin having carrier arm mounting holes, the mount comprising:
(a) a universal arm adapted to fixedly connect with the device; and
(b) a fastener adapted to fixedly mount the universal arm to at least one of the carrier arm mounting holes.

2. The mount of claim 1, wherein the device is a faucet controller.

3. The mount of claim 1, wherein the device is a valve.

4. The mount of claim 1, wherein the fastener comprises a ball joint.

5. A valve actuator assembly for operating a valve for a sink or basin and operable with a push pad, the valve actuator assembly comprising:
(a) a housing mountable to the sink or basin, the housing supporting a shaft and a valve, the shaft rotatable between a normal at rest position and a valve operating position;
(b) a rocker operably connected with a shaft, for rotation with the shaft, the rocker having an extent for operably urging a member supporting the valve when the shaft in is the valve operating position; and
(c) a push pad mechanism operably connected with the shaft and the push pad,
wherein the push pad is adapted to move the shaft between the normal at rest position and the valve operating position to selectively activate the valve.

6. A method of mounting a device to a sink or basin comprising the steps of:
(a) locating at least one hole in the underside of the sink or basin;
(b) inserting a fastener into the hole;
(c) activating the fastener to lock the fastener in the hole; and
(d) mounting a device to the sink or basin by attachment to the fastener.

7. The method of claim 6, the device comprising a faucet controller.

8. The method of claim 6, the fastener comprising an expandable plug.

9. The method of claim 6, the hole comprising a carrier arm mounting hole.

10. A faucet controller for operating a valve mounted in association with a sink or basin, having a carrier arm mounting hole comprising:
(a) a mounting means for mounting the valve to carrier arm mounting hole;
(b) a joystick actuator mountable on the valve for movement between a normal at rest position and a valve operating position; and
(c) a member connected with the joystick for forcing the joystick actuator into the valve operating position.
